(19) United States
(12) Patent Application Publication
(10) Pub. No.: US 2025/0267403 A1
(43) Pub. Date: Aug. 21, 2025

(54) NETWORKED AUTOMIXER SYSTEMS AND METHODS

(71) Applicant: Shure Acquisition Holdings, Inc., Niles, IL (US)

(72) Inventor: Gregory H. Canfield, Niles, IL (US)

(21) Appl. No.: 19/084,389

(22) Filed: Mar. 19, 2025

Related U.S. Application Data
(63) Continuation of application No. 17/960,009, filed on Oct. 4, 2022, now Pat. No. 12,289,584.
(60) Provisional application No. 63/262,074, filed on Oct. 4, 2021.

(51) Int. Cl. H04R 3/00; H04R 3/04; H04R 5/04

(52) U.S. Cl. CPC H04R 3/005; H04R 3/04; H04R 5/04; H04R 2420/01

(57) ABSTRACT

Systems and methods are disclosed for networked audio automixing using array microphones and an aggregator unit that participate in making a common gating decision to determine which channels to gate on and off. Through the use of such a network of array microphones having the capability to generate submix audio signals and reduced bandwidth metrics, as well as AEC processing capability, array microphone lobe selection can be enhanced while maximizing signal-to-noise ratio, increasing intelligibility, and increasing user satisfaction.

### CROSS-REFERENCE TO RELATED APPLICATIONS

This application is a continuation of U.S. patent application Ser. No. 17/960,009, filed on Oct. 4, 2022, which claims the benefit of U.S. Provisional Patent Application No. 63/262,074, filed on Oct. 4, 2021. The contents of these applications are fully incorporated herein by reference in their entirety.

### TECHNICAL FIELD

This application generally relates to systems and methods for networked audio automixing. In particular, this application relates to systems and methods for a network of array microphones and an aggregator unit that participate in making a common gating decision, and results in the generation of a final mix audio signal based on submix audio signals from the array microphones, where the submix audio signals are generated based on beamformed signals.

### BACKGROUND

Conferencing and presentation environments, such as boardrooms, conferencing settings, and the like, can involve the use of multiple microphones or microphone array lobes for capturing sound from various audio sources. The audio sources may include human speakers, for example. The captured sound may be disseminated to a local audience in the environment through amplified speakers (for sound reinforcement), and/or to others remote from the environment (such as via a telecast and/or a webcast). Each of the microphones or array lobes may form a channel.

Typically, captured sound may also include noise (e.g., undesired non-voice or non-human sounds) in the environment, including constant noises such as from ventilation, machinery, and electronic devices, and errant noises such as sudden, impulsive, or recurrent sounds like shuffling of paper, opening of bags and containers, chewing, typing, etc. To minimize noise in captured sounds, an automixer can be utilized to automatically gate and/or attenuate a particular microphone or array lobe's audio signal to mitigate the contribution of background, static, or stationary noise when it is not capturing human speech or voice. Voice activity detection (VAD) algorithms may also be used to minimize errant noises in captured sound by detecting the presence or absence of human speech or voice. Other noise reduction techniques can reduce certain background, static, or stationary noise, such as fan and HVAC system noise.

Current automixer units typically need to be connected to the audio signals of each individual microphone or array lobe in a system in order to determine which audio signals to gate on or off. The automixer unit then determines a gating decision to decide which audio signals (i.e., channels) to automatically attenuate, for example, by gating off the audio signals that contain only noise. However, as the number of microphones or array lobes becomes greater, the automixer unit may not have sufficient processing resources and/or enough available ports for connections to the microphones. Moreover, a large number of audio signals may need to be routed from the microphones to the automixer unit, which can necessitate additional wiring that can be difficult, impossible, and/or expensive.

In order to support larger numbers of audio signals, some current automixer systems may allow multiple automixer units to be linked together to obtain a coordinated gating decision. In this scenario, each of the automixer units are external to the microphones and generally require that one of the automixer units functions as a decisionmaker to determine the coordinated gating decision. However, such linked systems may require increased processing resources and cost due to the separate and dedicated processing in each of the automixer units. As such, it may be costly, infeasible, and undesirable to perform automixing of large numbers of microphones and/or array lobes using current automixing units and systems.

Furthermore, acoustic echo cancellation (AEC) may be desirable in audio and conferencing systems to, for example, prevent remote far end sounds played in an environment (e.g., speech from a far end participant of a conference played on a loudspeaker) from being sensed by microphones in the local environment and transmitted back to the remote participant. However, it can be computationally intensive and complex to perform AEC on each of a large number of microphone signals. In addition, when microphone signals have already been mixed, applying traditional AEC techniques to a mixed signal may not be as effective in cancelling echo.

Accordingly, there is an opportunity for systems and methods that address these concerns. More particularly, there is an opportunity for systems and methods for a network of array microphones that can each generate a submix audio signal based on beamformed signals and a common gating control signal, and also generate reduced bandwidth metrics based on the beamformed signals; and an aggregator unit that generates a final mix audio signal based on the submix audio signals and also generates the common gating control signal based on the reduced bandwidth metrics. Through the use of such a network of array microphones having the capability to generate submix audio signals and reduced bandwidth metrics, as well as AEC processing capability, array microphone lobe selection can be enhanced while maximizing signal-to-noise ratio, increasing intelligibility, reducing processing resources and signal routing complexity, and increasing overall user satisfaction.

### SUMMARY

The invention is intended to solve the above-noted problems by providing systems and methods that are designed to, among other things: (1) utilize a processing unit in each of a network of connected array microphones, where each processing unit determines reduced bandwidth metrics of beamformed signals and generates a submix audio signal based on the beamformed signals and a common gating control signal and/or a common gating decision; (2) aggregate the submix audio signals and reduced bandwidth metrics from each of the array microphones at an aggregator unit, which generates a final mix audio signal based on the submix audio signals and also generates the gating control signal based on the reduced bandwidth metrics; (3) generate echo-cancelled submix audio signals from the beamformed signals using the processing unit of each array microphone, based on the gating control signal and a reference signal; and (4) transmit the submix audio signals, reduced bandwidth metrics, and gating control signal between the array microphones and the aggregator unit over respective visible and/or hidden audio transport channels.

In an embodiment, an audio system may include a plurality of array microphones, and an aggregator unit in communication with the plurality of array microphones. Each of the plurality of array microphones may include a plurality of microphone elements that are each configured to provide a microphone signal, a beamformer in communication with the plurality of microphone elements, and a processing unit. The beamformer may be configured to generate one or more beamformed signals based on the microphone signals from each of the plurality of microphone elements, and each of the one or more beamformed signals may be associated with a lobe of the array microphone. The processing unit may be configured to receive the one or more beamformed signals from the beamformer, determine one or more reduced bandwidth metrics based on the one or more beamformed signals, and generate a submix audio signal based on the one or more beamformed signals and a gating control signal. The aggregator unit may be configured to generate a final mix audio signal based on the submix audio signals received from each of the plurality of array microphones, and generate the gating control signal based on the one or more reduced bandwidth metrics received from each of the plurality of array microphones.

In another embodiment, an audio system may include a plurality of array microphones, and an aggregator unit in communication with the plurality of array microphones. Each of the plurality of array microphones may include a plurality of microphone elements that are each configured to provide a microphone signal, a beamformer in communication with the plurality of microphone elements, and a processing unit. The beamformer may be configured to generate one or more beamformed signals based on the microphone signals from each of the plurality of microphone elements, and each of the one or more beamformed signals may be associated with a lobe of the array microphone. The processing unit may be configured to receive the one or more beamformed signals from the beamformer, determine one or more reduced bandwidth metrics based on the one or more beamformed signals, and generate an echo-canceled submix audio signal based on the one or more beamformed signals, a gating control signal, The processing unit may be configured to receive the one or more beamformed signals from the beamformer, determine one or more reduced bandwidth metrics based on the one or more beamformed signals, and generate a submix audio signal based on the one or more beamformed signals and a gating control signal. The aggregator unit may be configured to generate a final mix audio signal based on the echo-cancelled submix audio signals received from each of the plurality of array microphones, and generate the gating control signal based on the one or more reduced bandwidth metrics received from each of the plurality of array microphones.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic diagram of a system including a plurality of array microphones and an aggregator unit for automixing of beamformed audio signals, in accordance with some embodiments.

FIG. 2 is a schematic diagram of an aggregator unit for generating a gating control signal from reduced bandwidth metrics received from the array microphones, and generating a final mix audio signal from submix audio signals received from the array microphones, in accordance with some embodiments.

FIG. 3 is a schematic diagram of an array microphone including a beamformer and a processing unit for generating reduced bandwidth metrics from the beamformed signals, and for generating a submix audio signal from the beamformed signals and a gating control signal received from the aggregator unit, in accordance with some embodiments.

FIG. 4 is a flowchart illustrating operations for generating reduced bandwidth metrics and a submix audio signal using the array microphone of FIG. 3, and for generating a gating control signal and a final mix audio signal using the aggregator unit of FIG. 2, in accordance with some embodiments.

FIG. 5 is a schematic diagram of an array microphone including a beamformer and a processing unit for generating reduced bandwidth metrics from the beamformed signals, and for generating an echo-cancelled submix audio signal from the beamformed signals and a gating control signal received from the aggregator unit, in accordance with some embodiments.

FIG. 6 is a flowchart illustrating operations for generating reduced bandwidth metrics and an echo-cancelled submix audio signal using the array microphone of FIG. 5, and for generating a gating control signal and a final mix audio signal using the aggregator unit of FIG. 2, in accordance with some embodiments.

FIG. 7 is a schematic diagram of an aggregator unit for generating a gating control signal from reduced bandwidth metrics received from the array microphones, generating pre-processed mix audio signals, and generating a final mix audio signal from submix audio signals received from the array microphones, in accordance with some embodiments.

FIG. 8 is a schematic diagram of an array microphone including a beamformer and a processing unit for generating reduced bandwidth metrics from the beamformed signals, for generating a pre-processed submix audio signal, and for generating an echo-cancelled submix audio signal from the beamformed signals and a gating control signal received from the aggregator unit, in accordance with some embodiments.

FIG. 9 is a flowchart illustrating operations for generating reduced bandwidth metrics, a pre-processed submix audio signal, and an echo-cancelled submix audio signal using the array microphone of FIG. 8, and for generating a gating control signal, pre-processed mix audio signals, and a final mix audio signal using the aggregator unit of FIG. 7, in accordance with some embodiments.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

The systems and methods described herein can generate a final mix audio signal based on reduced bandwidth metrics and submix audio signals that have been generated by processing units included in a network of connected array microphones. The final mix audio signal can include audio that is generated based on a common gating control signal that takes into account the sound sensed by all of the array microphones. Each array microphone can generate a submix audio signal based on the common gating control signal that indicates the array microphone lobes across the network of array microphones that are gated on or gated off. The systems and methods can enhance the selection of array microphone lobes, which results in improved signal-to-noise ratio, better audio intelligibility, and increased user satisfaction. The final mix audio signal may conform to a desired audio mix such that the audio from certain channels of the array microphones is emphasized while audio from other channels of the array microphones is deemphasized or suppressed.

The reduced bandwidth metrics may be determined based on beamformed signals derived from microphone elements in the array microphones, and the submix audio signals may be generated based on the beamformed signals and a common gating control signal received from an aggregator unit. The aggregator unit can generate the final mix audio signal based on the submix audio signals, and also generate the gating control signal based on reduced bandwidth metrics from each of the array microphones.

By distributing the processing of the beamformed signals locally on each array microphone to produce the reduced bandwidth metrics and submix audio signals, the processing resources needed at the aggregator unit may be reduced. In addition, the routing and connections of signals between the array microphones and the aggregator unit may also be reduced, since only the submix audio signals and reduced bandwidth metrics need to be routed from the array microphones to the aggregator unit, instead of routing signals from all of the individual microphone elements of the array microphones to the aggregator unit. Moreover, the various signals (e.g., submix audio signals, reduced bandwidth metrics, and gating control signal) can be transmitted between the array microphones and the aggregator unit over visible and/or hidden audio transport channels (e.g., audio over IP network transport solutions), which can leverage existing capabilities and ports on the array microphones.

In some embodiments, the processing unit included in each of the array microphones may also process the beamformed signals to generate an echo-cancelled submix audio signal. In these embodiments, the echo-cancelled submix audio signal from each array microphone may be routed to the aggregator unit. By performing acoustic echo cancellation (AEC) locally on the beamformed signals in each array microphone, the need for processing resources in the aggregator unit can be further reduced since the aggregator unit does not need to perform computationally expensive AEC on a large number of signals. In addition, the routing and connection of signals may also be reduced between the array microphones and the aggregator unit in these embodiments.

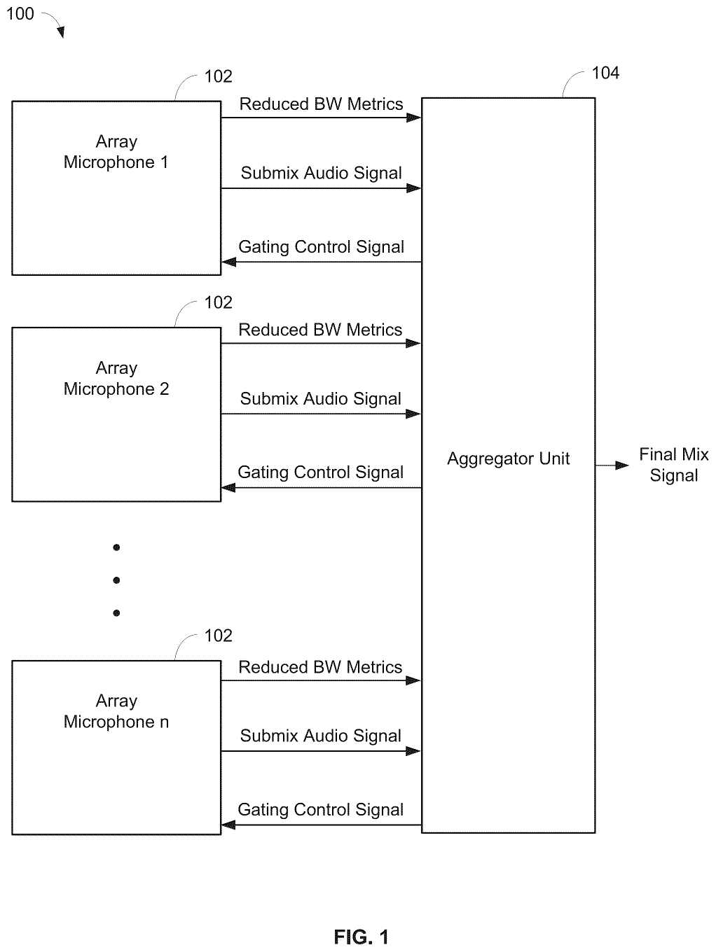

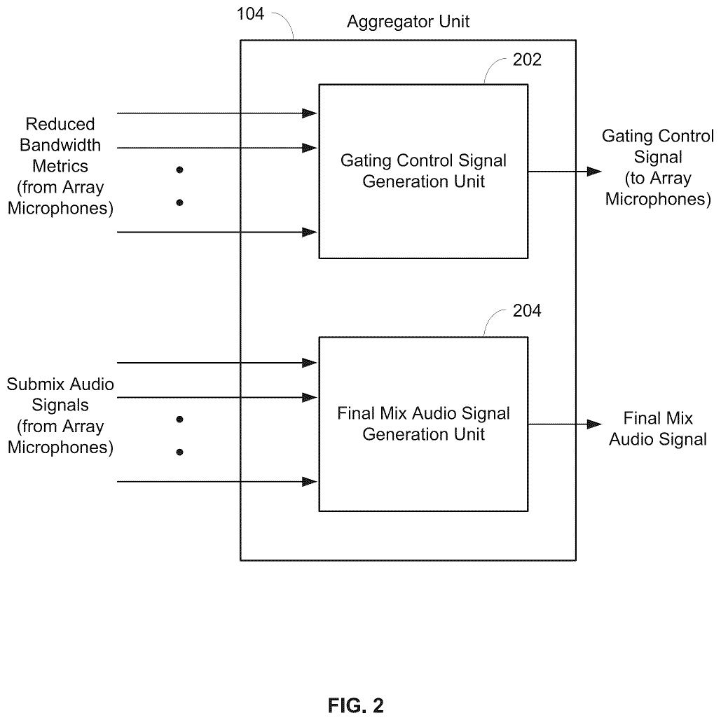

FIG. 1 is a schematic diagram of a system 100 including a plurality of array microphones 102 and an aggregator unit 104 for the automixing of beamformed audio signals. FIG. 2 is a schematic diagram of the aggregator unit 104 for generating a gating control signal from reduced bandwidth metrics received from the array microphones, and generating a final mix audio signal from submix audio signals received from the array microphones.

Environments such as conference rooms, churches, etc. may utilize the system 100 to facilitate communication with persons at a remote location and/or for sound reinforcement, for example. The environment may include desirable audio sources (e.g., human speakers) and/or undesirable audio sources (e.g., noise from ventilation, other persons, audio/visual equipment, electronic devices, etc.). The system 100 may result in the output of a final mix audio signal based on a common gating control signal that takes into account the audio captured by all of the array microphones 102, and attenuates and/or gates off the signals that contain undesirable audio.

Each of the array microphones 102 may detect sound in the environment, and be placed on or in a table, lectern, desktop, wall, ceiling, etc. so that the sound from the audio sources can be detected and captured, such as speech spoken by human speakers. Each of the array microphones may include any number of microphone elements, and be able to form multiple pickup patterns with lobes so that the sound from the audio sources can be detected and captured. Any appropriate number of microphone elements are possible and contemplated in each of the array microphones 102.

The various components included in the system 100 (i.e., the array microphones 102 and the aggregator unit 104) may be implemented using software executable by one or more computing devices, such as a laptop, desktop, tablet, smartphone, etc. Such a computer device may comprise one or more processors, memories, graphics processing units (GPUs), discrete logic circuits, application specific integrated circuits (ASIC), programmable gate arrays (PGA), field programmable gate arrays (FPGA), etc., one or more of which may be configured to perform some or all of the techniques described herein.

As described in more detail below, a processing unit in each of the array microphones 102 may generate reduced bandwidth metrics and a submix audio signal based on beamformed signals that are derived from the microphone elements in the array microphones 102. The submix audio signal may also be based on a gating control signal received from the aggregator unit 104. The submix audio signal generated by a particular array microphone 102 may be a mixture of the beamformed signals of that array microphone 102. The reduced bandwidth metrics and the submix audio signal may be transmitted to the aggregator unit 104 from array microphones 102.

The aggregator unit 104 may receive the submix audio signals from each of the array microphones 102 and generate a final mix audio signal. The aggregator unit 104 may also generate the gating control signal based on the reduced bandwidth metrics received from each of the array microphones 102. In embodiments, other suitable indicators may also be utilized by the aggregator unit 104 in generating the gating control signal. For example, the aggregator unit 104 may generate the gating signal based on an indication that may be determined based on values of one or more sensors. Such sensors may be in communication with the aggregator unit 104. The gating control signal may indicate the lobes of the array microphones 102 that are gated on or gated off. In embodiments, the array microphones 102 may generate echo-cancelled submix audio signals, which array microphones 102 may transmit to the aggregator unit 104. The aggregator unit 104 may generate the final mix audio signal based on these echo-cancelled submix audio signals. In some embodiments, at least some of the functionality of the aggregator unit 104 may be included in one or more of the array microphones 102 instead of as a separate standalone component of the system 100.

The reduced bandwidth metrics and submix audio signals from the array microphone 102, as well as the gating control signal from the aggregator unit 104, may be transmitted over any suitable audio transport channels. In embodiments, the reduced bandwidth metrics, submix audio signals, and gating control signal may be transmitted over audio transport channels and/or be transmitted over hidden audio transport channels. The audio transport channels may be, for example, audio over IP network transport solutions. In embodiments, the audio transport channels utilized for transmission may be encrypted. Hidden audio transport channels may be utilized for certain signals in some embodiments in order to protect the signals from undesired or unauthorized content and/or routing modifications, and also to simplify user interaction with the system so that users only see the channels that can be routed by them.

The reduced bandwidth metrics generated by the array microphones 102 may represent a measurement of the beamformed signals generated by beamformers in the array microphones 102. By using reduced bandwidth metrics, the amount of information representing the beamformed signals may be minimized. For example, the full bandwidth of the beamformed signals does not need to be transmitted from the array microphones 102 to the aggregator unit 104 since the reduced bandwidth metrics may sufficiently represent the beamformed signals. In embodiments, the beamformed signals may have been processed prior to the reduced bandwidth metrics being generated, such as by adjusting their gain and/or equalization. In embodiments, a distinct signal-specific reduced bandwidth metric may be generated for each beamformed signal in an array microphone 102, and all of the signal-specific reduced bandwidth metrics may be combined into the reduced bandwidth metrics that are ultimately transmitted from the array microphone 102 to the aggregator unit 104.

The reduced bandwidth metrics may include, for example, a calculation of the basic level measurement of each of the beamformed signals in the array microphones 102. In an embodiment, the basic level measurement may be calculated by applying a bandpass filter (or other weighting filter) on a beamformed signal, then rectifying and averaging the filtered beamformed signal to obtain a level estimate of the beamformed signal. In embodiments, the reduced bandwidth metrics may include other information derived from the full bandwidth signals or state information. For example, the reduced bandwidth metrics may also include information related to the localization of talkers and/or other desirable sounds in the environment, the deployment of lobes (e.g., locations), Linear Predictive Coding (LPC) coefficients, and/or audio signals transformed with various compression algorithms.

Each of the submix audio signals generated by the array microphones 102 may be a mix of the beamformed signals generated by the beamformer in a particular array microphone 102. The submix audio signals may each take into account the common gating control signal received from the aggregator unit 104 to determine which channels to gate on or off. The submix audio signal may be encoded as a 24-bit audio channel, in some embodiments.

As shown in FIG. 2, the aggregator unit 104 may receive the reduced bandwidth metrics from each of the array microphones 102. The aggregator unit 104 may comprise a gating control signal generation unit 202 and a final mix audio signal generation unit 204. The gating control signal generation unit 202 in the aggregator unit 104 may generate one or more gating control signals based on the received reduced bandwidth metrics. A gating control signal may be transmitted from the gating control signal generation unit 202 of the aggregator unit 104 to each of the array microphones 102. In particular, the gating control signal may be transmitted to all of the array microphones 102, such that each of the array microphones 102 has knowledge of which channels are to be attenuated and/or gated on or off, including channels of array microphones other than the array microphone that receives the gating control signal. In embodiments, there may be a different gating control signal sent to each of the array microphones 102, where each gating control signal is based on a common gating decision calculation made by the gating control signal generation unit 202. These different gating control signals may include reduced information, such as the specific channels or subset of channels for a particular array microphone 102 that are to be attenuated and/or gated on or off.

In embodiments, the gating control signal can denote which channels to gate on to provide captured audio without suppression (or in certain embodiments, with minimal suppression) in response to determining that the captured audio contains human speech and/or according to certain channel selection rules, for example. Similarly, the gating control signal can denote which channels to gate off to reduce the strength of certain captured audio in response to determining that the captured audio in a channel is a background, static, or stationary noise, for example. In embodiments, the gating control signal may be included in one or more frames (e.g., in a signal conforming to the Dante standard and/or another networked audio transport system) that may indicate the gating parameters for each channel.

In embodiments, the gating control signal may indicate a network gain. The gating control signal may be calculated based on calculations of a MAX bus, reverberation inhibit signal, and noise adaptive threshold. The MAX bus may denote the maximum level of a scaled input for any input signal. The reverberation inhibit signal may that track a fraction, such as one fourth, of a maximum of any non-scaled basic level measurements. The noise adaptive threshold may be used to determine if a beamformed audio signal is above a background noise threshold. Exemplary embodiments of the gating control signal, calculating the basic level measurement, generating the submix audio signal, and generating the MAX bus, reverberation inhibit signal, and noise adaptive threshold, as well as exemplary embodiments of other networked automixers, are described in commonly-assigned U.S. Pat. No. 8,644,477 entitled “Digital Microphone Automixer”, which is incorporated by reference in its entirety herein.

The aggregator unit 104 may also receive the submix audio signals from each of the array microphones 102. A final mix audio signal generation unit 204 in the aggregator unit 104 may generate the final mix audio signal of the system 100 based on the received submix audio signals. Since the processing unit on each of the array microphones 102 has already taken the common gating control signal into account when generating a respective submix audio signal, the final mix audio signal generation unit 204 can mix the submix audio signals together to generate the final mix audio signal without the need for additional processing. In other words, the aggregator unit 104 may not need to attenuate and/or gate on or off any particular audio channels because the submix audio signals from the array microphones 102 already include contributions from the audio channels that are to be included in the final mix audio signal (as specified by the gating control signal). The final mix audio signal may conform to a desired audio mix such that the audio signals from certain channels of the array microphones 102 are emphasized and the audio signals from other channels of the array microphones 102 are deemphasized or suppressed.

In some embodiments, the aggregator unit 104 may generate the final mix audio signal by also mixing one or more local microphone signals (not shown) with the submix audio signals from each of the array microphones 102. The local microphone signals may be directly transmitted to the aggregator unit 104 in these embodiments. In addition, the aggregator unit 104 may generate the gating control signal based on the reduced bandwidth metrics from each of the array microphones 102 and also based on information derived from the local microphone signal(s).

In embodiments, the aggregator unit 104 may determine one or more latency values that can be transmitted to the array microphones 102, in order to ensure the proper generation of the submix audio signals, reduced bandwidth metrics, gating control signal, and/or other signals. For example, the submix audio signals and reduced bandwidth metrics calculated by each of the array microphones 102 should generally be time aligned with each other when being transmitted to the aggregator unit 104 for processing so that the aggregator unit 104 properly generates the gating control signal. The array microphones 102 can delay the generation and/or transmission of signals based on the latency values received from the aggregator unit 104. Properly generating and transmitting the signals can ensure that the final mix audio signal generated by the aggregator unit 104 is of higher quality (e.g., a channel is gated on at the correct time to include speech from a talker, etc.). The aggregator unit 104 may determine the latency values based on fixed and/or measured delay values related to each of the array microphones 102.

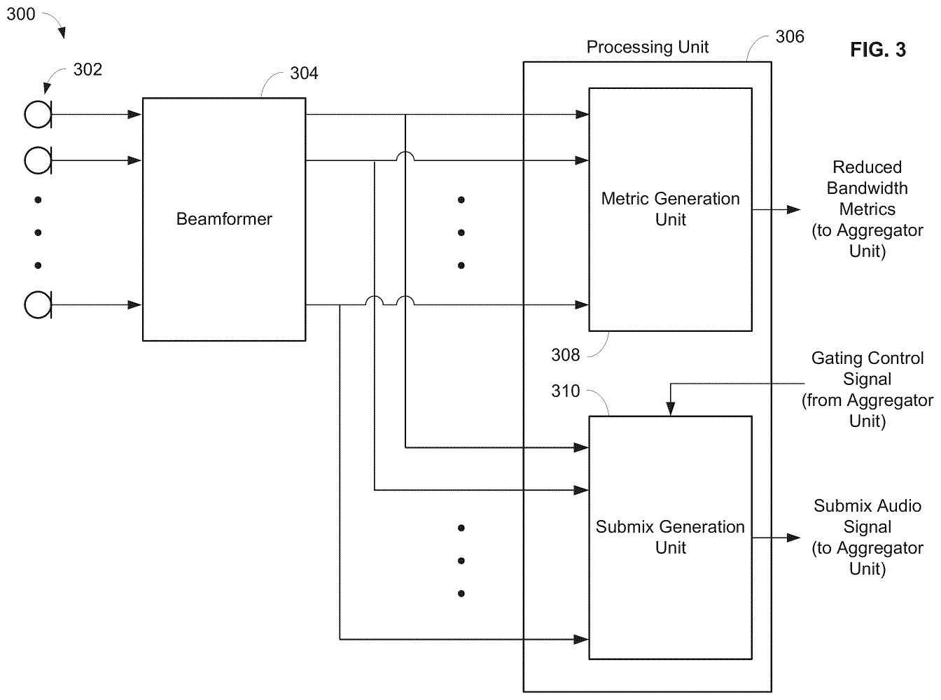

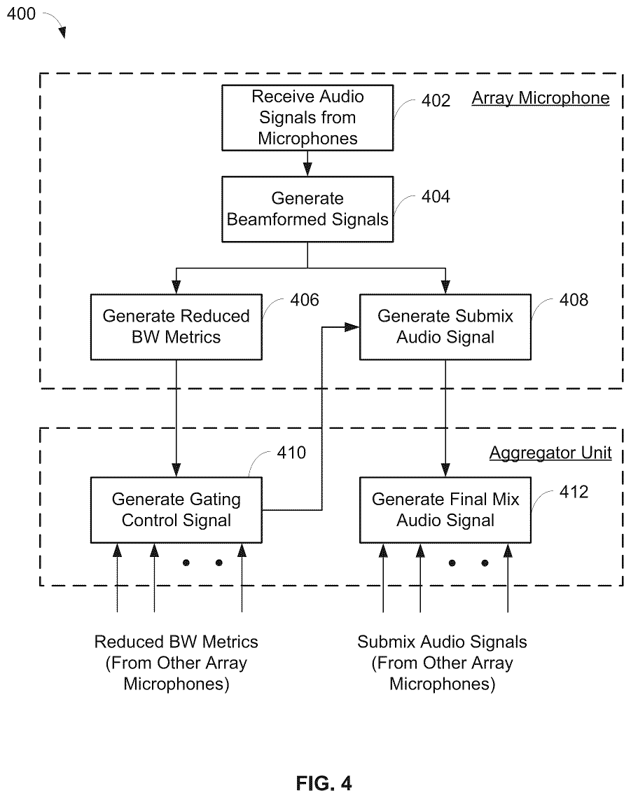

FIG. 3 is a schematic diagram of an array microphone 300 including a beamformer 304 and a processing unit 306 for generating reduced bandwidth metrics from beamformed signals, and for generating a submix audio signal from the beamformed signals and a gating control signal received from the aggregator unit 104. FIG. 4 is a flowchart of a process 400 for generating reduced bandwidth metrics and a submix audio signal using the array microphone 300 of FIG. 3, and for generating a gating control signal and a final mix audio signal using the aggregator unit of FIG. 2. The process 400 as usable with the array microphone 300 is described in more detail below.

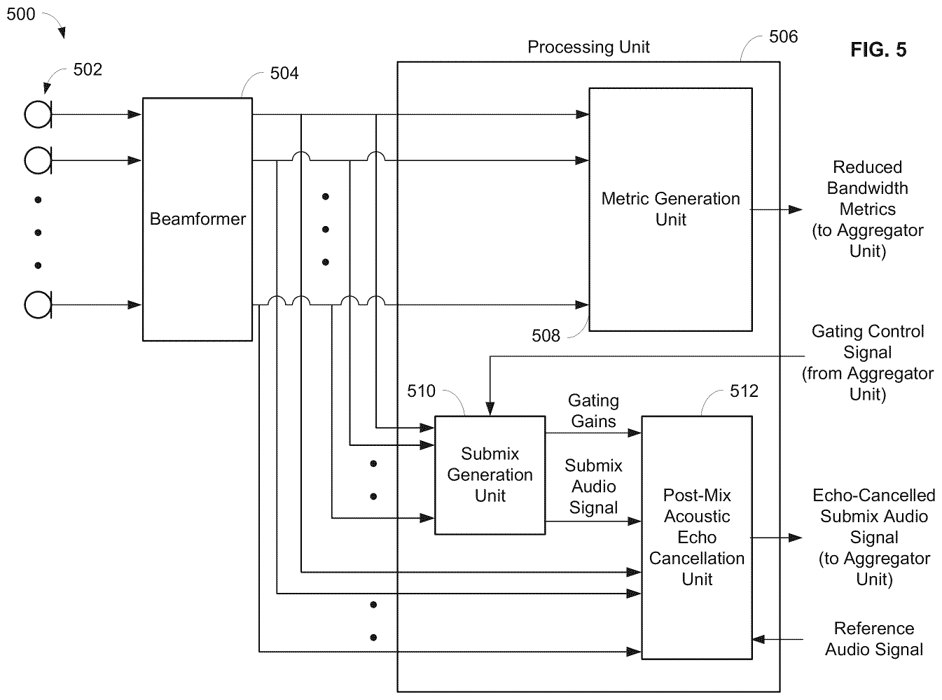

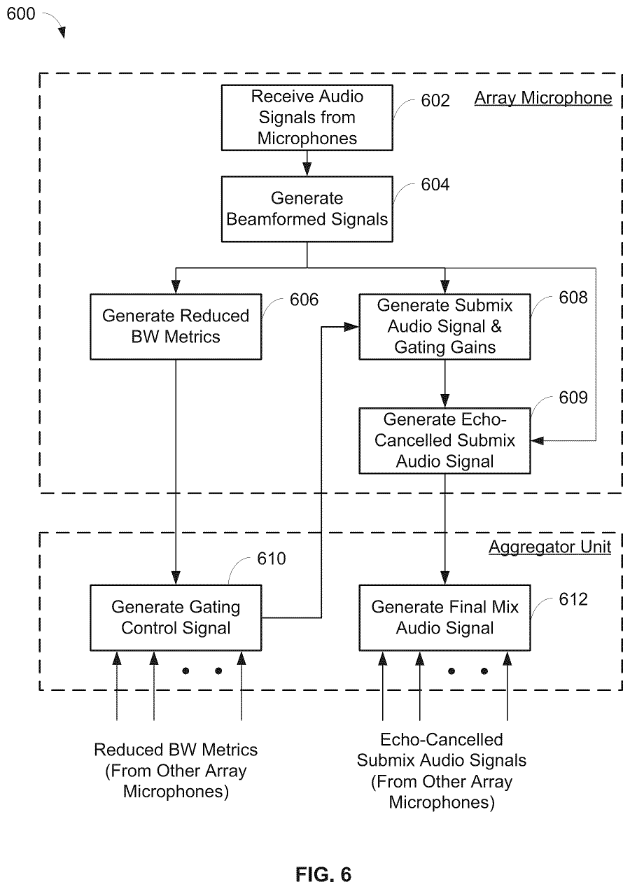

FIG. 5 is a schematic diagram of an array microphone 500 including a beamformer 504 and a processing unit 506 for generating reduced bandwidth metrics from beamformed signals, and for generating an echo-cancelled submix audio signal from the beamformed signals and a gating control signal received from the aggregator unit 104. FIG. 6 is a flowchart of a process 600 for generating reduced bandwidth metrics and an echo-cancelled submix audio signal using the array microphone 500 of FIG. 5, and for generating a gating control signal and a final mix audio signal using the aggregator unit of FIG. 2. The process 600 as usable with the array microphone 500 is described in more detail below.

One or more processors and/or other processing components (e.g., analog to digital converters, encryption chips, etc.) within the array microphones 300, 500 and aggregator unit 104 may perform any, some, or all of the steps of the processes 400, 600. One or more other types of components (e.g., memory, input and/or output devices, transmitters, receivers, buffers, drivers, discrete components, etc.) may also be utilized in conjunction with the processors and/or other processing components to perform any, some, or all of the steps of the processes 400, 600.

As shown in FIG. 4, steps 402, 404, 406, and 408 of the process 400 may be performed by the microphone elements 302, beamformer 304, and processing unit 306 of the array microphone 300 shown in FIG. 3. The processing unit 306 of the array microphone 300 may include the metric generation unit 308 and the submix generation unit 310. Similarly, steps 602, 604, 606, 608, and 609 of the process 600 shown in FIG. 6 may be performed by the microphone elements 502, beamformer 504, and processing unit 506 of the array microphone 500 shown in FIG. 5. The processing unit 506 of the array microphone 500 may include the metric generation unit 508, the submix generation unit 510, and the post-mix acoustic echo cancellation unit 512. Steps 410, 412, 610, and 612 of the processes 400 and 600 shown in FIGS. 4 and 6 may be performed by the aggregator unit 104 shown in FIG. 2.

At steps 402, 602, the audio signals from each of the microphone elements 302, 502 may be received by the beamformer 304, 504. Each of the microphone elements 302, 502 may detect sound in the environment and convert the sound to an analog or digital audio signal. In some embodiments, the microphone elements 302, 502 may be arranged in concentric rings and/or harmonically nested. The microphone elements 302, 502 may be arranged to be generally symmetric, in some embodiments. In other embodiments, the microphone elements 302, 502 may be arranged asymmetrically or in another arrangement. In further embodiments, the microphone elements 302, 502 may be arranged on a substrate, placed in a frame, or individually suspended, for example. An embodiment of an array microphone is described in commonly assigned U.S. Pat. No. 9,565,493, which is hereby incorporated by reference in its entirety herein. In embodiments, the microphone elements 302, 502 may be unidirectional microphones that are primarily sensitive in one direction. In other embodiments, the microphone elements 302, 502 may have other directionalities or polar patterns, such as cardioid, subcardioid, or omnidirectional, as desired.

The microphone elements 302, 502 may be any suitable type of transducer that can detect the sound from an audio source and convert the sound to an electrical audio signal. In an embodiment, the microphone elements 302, 502 may be micro-electrical mechanical system (MEMS) microphones. In other embodiments, the microphone elements 302, 502 may be condenser microphones, balanced armature microphones, electret microphones, dynamic microphones, and/or other types of microphones. In embodiments, the microphone elements 302, 502 may be arrayed in one dimension or two dimensions.

At step 404, 604, one or more pickup patterns may be formed by the beamformer 304, 504 in the array microphone 300, 500 from the audio signals of the microphone elements 302, 502 that were received at step 402, 602. The beamformer 304, 504 may generate beamformed signals corresponding to each of the pickup patterns at step 404, 604. The pickup patterns may be composed of one or more lobes, e.g., main, side, and back lobes. The beamformer 304, 504 may be any suitable beamformer, such as a delay and sum beamformer or a minimum variance distortionless response (MVDR) beamformer.

The beamformed signals from the beamformer 304, 504 may be transmitted within the array microphone 300, 500 to the processing unit 306, 506. In particular, the beamformed signals from the beamformer 304, 504 may be transmitted to the metric generation unit 308, 508 and to the submix generation unit 310, 510 in the processing unit 306, 506. In addition, in the processing unit 506 of the array microphone 500, the beamformed signals from the beamformer 504 may also be transmitted to the post-mix acoustic echo cancellation unit 512.

At step 406, 606, the metric generation unit 308, 508 of the processing unit 306, 506 may generate reduced bandwidth metrics based on the beamformed signals received from the beamformer 304, 504. The reduced bandwidth metrics may represent a measurement of the beamformed signals, and may include, for example, the basic level measurement of the beamformed signals and/or other information derived from the full bandwidth signals or state information, as described previously. The reduced bandwidth metrics generated at step 406, 606 may be transmitted from the metric generation unit 308, 508 to the aggregation unit 104.

At step 410, 610, the aggregation unit may receive the reduced bandwidth metrics generated at step 406, 606 by each of the array microphones 300, 500, and generate the global gating control signal using the gating control signal generation unit 202. The reduced bandwidth metrics represent the beamformed signals in each of the array microphones 300, 500. The gating control signal can denote which channels of the array microphones 300, 500 to gate on or off, and/or to suppress or not suppress, as described previously. The gating control signal may be transmitted from the aggregator unit 104 to each of the array microphones 300, 500.

At step 408, 608, the submix generation unit 310, 510 may receive the beamformed signals from the beamformer 304, 504 (generated at step 404, 604) and also receive the gating control signal from the aggregator unit 104 (generated at step 410, 610). The submix generation unit 310, 510 may generate a submix audio signal at step 408, 608 based on the beamformed signals and the gating control signal. In particular, the submix generation unit 310, 510 may use the information in the gating control signal to apply processing to the beamformed signals in the array microphone 300, 500 to attenuate and/or gate them on or off.

In an embodiment including the array microphone 300, the submix audio signal generated at step 408 by the submix generation unit 310 may be transmitted to the aggregator unit 104. In some embodiments, the submix audio signal generated at step 408 may be processed for noise reduction, gain adjustment, acoustic echo cancellation, and/or other signal processing (e.g., by an array microphone, such as array microphone 300 and/or 500) before being transmitted to the aggregator unit 104. At step 412, the aggregator unit 104 may receive the submix audio signal from each of the array microphones 300 and generate the final mix audio signal. The final mix audio signal may reflect the desired audio mix of beamformed signals/channels from the array microphones 300 (as embodied in the submix audio signals), and as specified by the gating control signal. In embodiments, the final mix audio signal may be transmitted to a remote location (e.g., far end of a conference) and/or be played in the environment for sound reinforcement, for example. In some embodiments, the final mix audio signal generated at step 412 may be processed for noise reduction, gain adjustment, acoustic echo cancellation, and/or other signal processing.

In another embodiment including the array microphone 500, the submix audio signal generated at step 608 by the submix generation unit 510 may be transmitted to post-mix acoustic echo cancellation unit 512 in the processing unit 506 of the array microphone 500. The submix generation unit 510 may have also determined the gating gains of the submix audio signal that are used in generating the submix audio signal at step 608. In embodiments, the gating control signal generation unit 202 may perform a number of calculations that are used to determine the gating gains, and the results of these calculations may be transmitted as part of the gating control signal to the submix generation unit 510 from the gating control signal generation unit 202. In other embodiments, the gating control signal generation unit 202 may determine the gating gains of the submix audio signal based on the results of the calculations performed in the gating control signal generation unit 202, and the gating gains may be transmitted as part of the gating control signal to the submix generation unit 510 from the gating control signal generation unit 202. The submix audio signal, gating gains of the submix audio signal, the beamformed signals, and a reference audio signal may be used by the post-mix acoustic echo cancellation unit 512 to generate an echo-cancelled submix audio signal at step 609.

The gating gains are applied to each of the beamformed audio signals when they are summed into the submix audio signal used in the post-mix acoustic echo cancellation unit 512. In embodiments, the gating control signal generation unit 202 may calculate a number of open microphone attenuation (NOMA) scaling factor and an off attenuation scaling factor. The NOMA scaling factor and the off attenuation scaling factor may be transmitted as part of the gating control signal from the gating control signal generation unit 202. The per-channel gating gain may be generated by the submix generation unit 510 by multiplying the NOMA scaling factor and the off attenuation scaling factor after applying averaging/smoothing filtering.

Accordingly, the submix generation unit 510 of the processing unit 506 in the array microphone 500 may provide the gating gains that have been applied to each channel to the post-mix acoustic echo cancellation unit 512. Furthermore, the gating gains are based on a network-wide common gating decision, as opposed to being based on a local gating decision. In this way, the post-mix acoustic echo cancellation unit 512 in combination with the submix generation unit 510 may have improved performance since their combined behavior may be influenced by channels from all of the array microphones in the system.

The echo-cancelled submix audio signal may mitigate the sound in the reference audio signal. The reference audio signal may include, for example, the sound received from a remote location that is being played on a loudspeaker in the local environment. Another exemplary reference audio signal may be locally generated or played sounds that may be picked up by local microphones and are desired to be removed from near end speech. A further exemplary reference audio signal may be the sound of a near end talker in a different part of the room that has been amplified into a loudspeaker near the array microphone. In some embodiments, different reference audio signals may be transmitted to different array microphones 500 in the system.

In particular, the post-mix acoustic echo cancellation unit 512 may generate the echo-cancelled submix audio signal based on the submix audio signal from the submix generation unit 510, information gathered from the beamformed audio signals, and the reference audio signal. The submix audio signal and the beamformed signals may be processed in the frequency domain by the post-mix acoustic echo cancellation unit 512, in order to generate the echo-cancelled submix audio signal. The post-mix acoustic echo cancellation unit 512 may include a signal selection mechanism that is configured to select at least one of the beamformed signals such that the echo-cancelled submix audio signal is generated based on the submix audio signal, information gathered from the selected beamformed signal, and the reference audio signal. Information gathered from the selected beamformed signal may include, for example, measurements of the background error power and hidden error power of the selected beamformed signal. The signal selection mechanism may include a switch, a mixer that could select a particular beamformed signal (by attenuating some or all of the other beamformed signals), and/or another suitable signal selection mechanism. Exemplary embodiments of post-mix acoustic echo cancellation systems and method are described in commonly-assigned U.S. Pat. No. 10,367,948 entitled “Post-Mixing Acoustic Echo Cancellation Systems and Methods”, which is incorporated by reference in its entirety herein. In some embodiments, the echo-cancelled submix audio signal may be further processed to reduce noise, prior to being transmitted to the aggregator unit 104.

At step 612, the aggregator unit 104 may receive the echo-cancelled submix audio signal from each of the array microphones 500 and generate the final mix audio signal. The final mix audio signal may reflect the desired audio mix of beamformed signals/channels from the array microphones 500 (as embodied in the echo-cancelled submix audio signals), and as specified by the gating control signal. In embodiments, the final mix audio signal may be transmitted to a remote location (e.g., far end of a conference) and/or be played in the environment for sound reinforcement, for example. Since the final mix audio signal generated at step 612 includes the echo-cancelled submix audio signals from each of the array microphones 500, the final mix audio signal can be transmitted to a remote location, for example, without the undesirable echo of persons at the remote location hearing their own speech and sound.

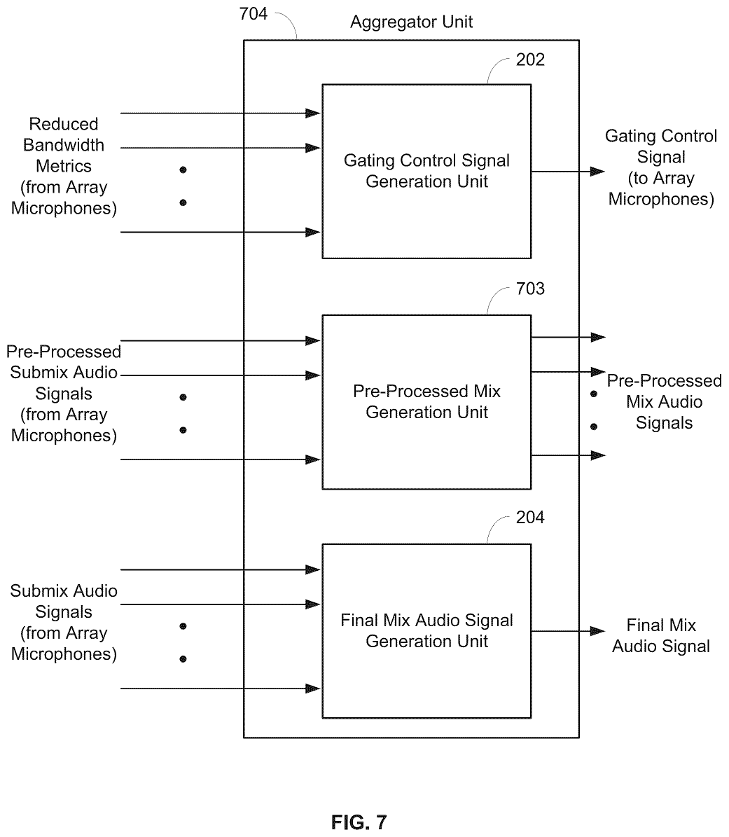

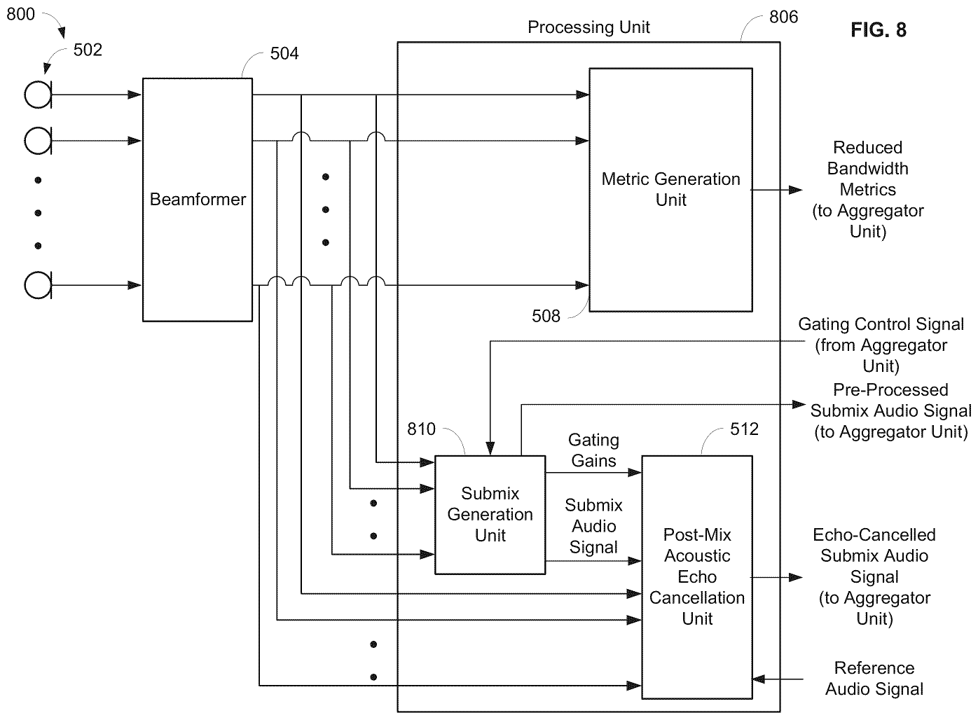

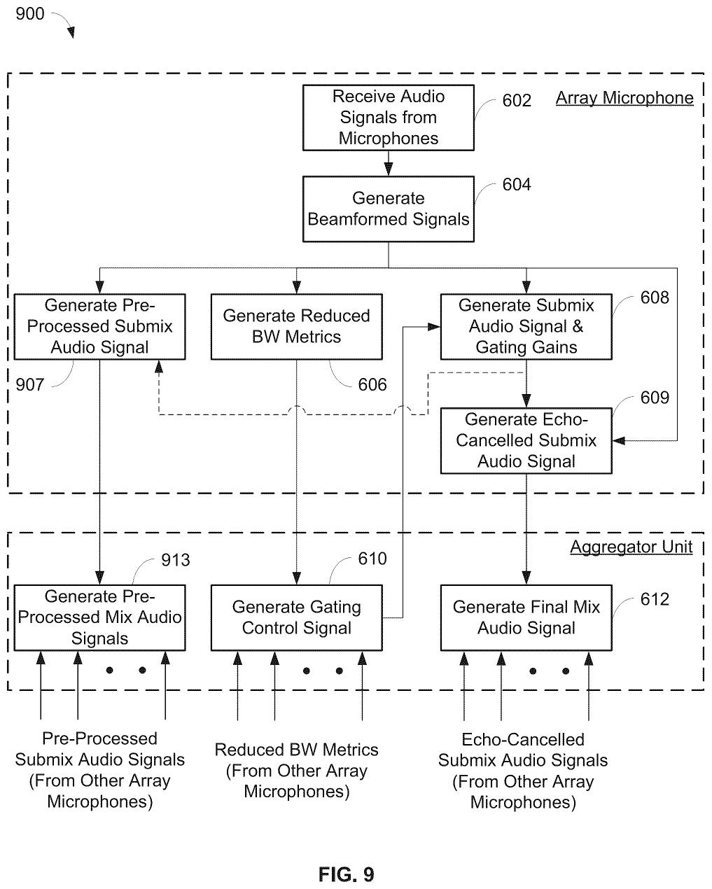

A further embodiment enables the generation of gated or ungated pre-processed mix audio signals that can be used for local sound reinforcement, for example. This embodiment includes an aggregator unit 704 of FIG. 7 in communication with an array microphone 800 with a processing unit 806 and a submix generation unit 810 of FIG. 8, and is further described with reference to the process 900 of FIG. 9. For simplicity, in FIGS. 7-8, the functionality of other components of the aggregator unit 704 and array microphone 800 that are not discussed below are as described previously. Similarly, the functionality of other steps in the process 900 that are not discussed below are also as described previously.

The processing unit 806 of the array microphone 800 may include a submix generation unit 810 that also generates a pre-processed submix audio signal from the beamformed signals received from the beamformer 504, such as at step 907 of the process 900. The pre-processed submix audio signal from the array microphone 800 may be gated or ungated, and may or may not have been processed for noise reduction, gain adjustment, and/or acoustic echo cancellation purposes. When the pre-processed submix audio signal is gated, then the submix generation unit 810 may generate the gated pre-processed submix audio signal from the beamformed signals and based on gating gains (such as those generated at step 608). The pre-processed submix audio signal may be transmitted from the submix generation unit 810 to the aggregator unit 704.

The aggregator unit 704 may generate the pre-processed mix audio signals using a pre-processed mix generation unit 703, such as at step 913 of the process 900. The aggregator unit 704 may also receive pre-processed submix audio signals from other array microphones 800 in the system in order to generate the pre-processed mix audio signals. In embodiments, the pre-processed mix audio signals may be gated or ungated, depending on whether the pre-processed submix audio signals received from the array microphones 800 are gated or ungated. The pre-processed mix audio signals may be a desired audio mix of the pre-processed submix audio signals from the array microphones 800. In embodiments, the pre-processed mix audio signals may be played in the environment for local sound reinforcement, for example.

In general, a computer program product in accordance with the embodiments includes a computer usable storage medium (e.g., standard random access memory (RAM), an optical disc, a universal serial bus (USB) drive, or the like) having computer-readable program code embodied therein, wherein the computer-readable program code is adapted to be executed by a processor (e.g., working in connection with an operating system) to implement the methods described below. In this regard, the program code may be implemented in any desired language, and may be implemented as machine code, assembly code, byte code, interpretable source code or the like (e.g., via C, C++, Java, ActionScript, Objective-C, JavaScript, CSS, XML, and/or others).

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1-20. (canceled)

21. An audio system, comprising:
(A) a plurality of array microphones each comprising:
a plurality of microphone elements, wherein each of the plurality of microphone elements is configured to provide a microphone signal;
a beamformer in communication with the plurality of microphone elements, wherein the beamformer is configured to generate one or more beamformed signals based on the microphone signals from each of the plurality of microphone elements and to generate state information associated with a state of the beamformer, and wherein each of the one or more beamformed signals is associated with a lobe of the array microphone; and
a processing unit configured to receive the one or more beamformed signals and the state information from the beamformer, determine one or more reduced bandwidth metrics based on the one or more beamformed signals and the state information, and generate a submix audio signal based on the one or more beamformed signals and a gating control signal; and
(B) an aggregator unit in communication with the plurality of array microphones, wherein the aggregator unit is configured to:
generate a final mix audio signal based on the submix audio signals received from each of the plurality of array microphones; and
generate the gating control signal based on the one or more reduced bandwidth metrics received from each of the plurality of array microphones.

22. The audio system of claim 21, wherein the one or more reduced bandwidth metrics comprise a basic level measurement.

23. The audio system of claim 22, wherein the basic level measurement represents an average level estimate of the one or more beamformed signals.

24. The audio system of claim 21, wherein the aggregator unit is further configured to generate a noise adaptive threshold signal that denotes that one of the beamformed signals is above a background noise threshold.

25. The audio system of claim 24, wherein the aggregator unit is further configured to generate the gating control signal based on the one or more reduced bandwidth metrics and the noise adaptive threshold signal.

26. The audio system of claim 21, wherein one of the plurality of array microphones comprises the aggregator unit.

27. The audio system of claim 21, wherein the one or more reduced bandwidth metrics comprise one or more of information related to a location of a desirable sound source or a location of the lobe of the array microphone.

28. The audio system of claim 21,
wherein the processing unit of each of the plurality of array microphones is further configured to generate an echo-cancelled submix audio signal based on the one or more beamformed signals, the gating control signal, and a reference audio signal; and
wherein the aggregator unit is further configured to generate the final mix audio signal based on the echo-cancelled submix audio signals received from each of the plurality of array microphones.

29. The audio system of claim 28, wherein the processing unit of each of the plurality of array microphones is further configured to process the echo-cancelled submix audio signal for noise reduction, based on the gating control signal.

30. The audio system of claim 28:
wherein the processing unit of each of the plurality of array microphones is further configured to generate a pre-processed submix audio signal, based on the one or more beamformed signals; and
wherein the aggregator unit is further configured to generate a pre-processed mix audio signal based on the pre-processed submix audio signal received from each of the plurality of array microphones.

31. A method, comprising:
generating, using a beamformer in each of a plurality of array microphones and based on microphone signals from each of a plurality of microphone elements in one of the plurality of array microphones, one or more beamformed signals and state information associated with a state of the beamformer, wherein each of the one or more beamformed signals is associated with a lobe of one of the plurality of array microphones;
determining, using a processing unit in each of the plurality of array microphones and based on the one or more beamformed signals and the state information, one or more reduced bandwidth metrics;
generating, using the processing unit in each of the plurality of array microphones and based on the one or more beamformed signals and a gating control signal, a submix audio signal;
generating, using an aggregator unit in communication with the plurality of array microphones and based on the submix audio signal received from each of the plurality of array microphones, a final mix audio signal; and
generating, using the aggregator unit and based on the one or more reduced bandwidth metrics received from each of the plurality of array microphones, the gating control signal.

32. The method of claim 31, wherein the one or more reduced bandwidth metrics comprise a basic level measurement.

33. The method of claim 32, wherein the basic level measurement represents an average level estimate of the one or more beamformed signals.

34. The method of claim 31, further comprising generating, using the aggregator unit, a noise adaptive threshold signal that denotes that one of the beamformed signals is above a background noise threshold.

35. The method of claim 34, wherein generating the gating control signal comprises generating the gating control signal based on the one or more reduced bandwidth metrics and the noise adaptive threshold signal.

36. The method of claim 31, wherein one of the plurality of array microphones comprises the aggregator unit.

37. The method of claim 31, wherein the one or more reduced bandwidth metrics comprise one or more of information related to a location of a desirable sound source or a location of the lobe of the one of the plurality of array microphones.

38. The method of claim 31,
further comprising generating, using the processing unit of each of the plurality of array microphones, an echo-cancelled submix audio signal based on the one or more beamformed signals, the gating control signal, and a reference audio signal; and
wherein generating the final mix audio signal further comprises generating, using the aggregator unit, the final mix audio signal based on the echo-cancelled submix audio signals received from each of the plurality of array microphones.

39. The method of claim 38, further comprising processing, using the processing unit of each of the plurality of array microphones, the echo-cancelled submix audio signal for noise reduction, based on the gating control signal.

40. The method of claim 38, further comprising:
generating, using the processing unit of each of the plurality of array microphones, a pre-processed submix audio signal, based on the one or more beamformed signals; and
generating, using the aggregator unit, a pre-processed mix audio signal based on the pre-processed submix audio signals received from each of the plurality of array microphones.
